(19) United States
(12) Patent Application Publication
(10) Pub. No.: US 2006/0227147 A1
(43) Pub. Date: Oct. 12, 2006

(54) Method and apparatus for an image presentation device with illumination control for black image processing

(76) Inventors: Toon Diels, Balen (BE); Robert J. Pantalone, Clearwater, FL (US); Patrick J. Verdon, Palm Harbor, FL (US); Israel J. Morejon, Tampa, FL (US)

Correspondence Address: MILLER JOHNSON SNELL CUMMISKEY, PLC, 800 CALDER PLAZA BUILDING, 250 MONROE AVE N W, GRAND RAPIDS, MI, 49503-2250, US

(21) Appl. No.: 11/100,717

(22) Filed: Apr. 7, 2005

(51) Int. Cl. G09G 5/02

(52) U.S. Cl. 345/589

(57) ABSTRACT

An image presentation device (100) includes a microdisplay panel (150) and a set of light sources (122, 124, 126) operable to emit light of different colors. An optical structure (140) couples the set of the light sources (122, 124, 126) to the microdisplay panel (150). A controller (110) is responsive to the data obtained from an analysis of each image frame, to selectively and individually vary output intensity for the light sources (122, 124, 126) to achieve a particular illumination level and corresponding ratio for processed images.

### FIELD OF THE INVENTION

This invention relates generally to image processing for improving the perceived contrast in a micro-display panel

### BACKGROUND

Image projection systems that use micro-display panels, such as digital mirror devices (DMD), are well known in the art. A desirable feature of such systems is to provide good color contrast, particularly when processing images with dark scenes or with a high black content. One approach to providing black image processing in DMD systems is described in U.S. Pat. No. 5,467,146, issued to Huang et al., on Nov. 14, 1995, and entitled “Illumination Control Unit For Display System With Spatial Light Modulator,” which is hereby incorporated by reference in its entirety. Here, a mechanical aperture or optical shutter is interposed between a-light source and DMD panel to control light to the DMD panel. The aperture can be closed when processing a black image or frames and be partially opened or closed depending on a desired level of brightness which can be determined on a frame-by-frame basis. While such a system has been widely used in commercial applications, disadvantages of using this-approach are the costs associated with the shutter and other elements required to implement the shutter. It is desirable to have an illumination control system with improvements in terms of costs, performance, and flexibility.

### BRIEF DESCRIPTION OF THE DRAWINGS

FIG. 1 shows an image presentation device based on a DMD panel, in accordance with the preferred embodiment of the invention.

FIG. 2 shows a representation of a transformation system for generating light source controlling signals, in accordance with a preferred embodiment of the invention.

FIG. 3 shows representative look-up tables useful for generating light source controlling signals, in accordance with a preferred embodiment of the invention.

The above and other features and advantages of the invention will be further understood from the following description of the preferred embodiments thereof, taken in conjunction with the accompanying drawings.

### DETAILED DESCRIPTION OF THE PREFERRED EMBODIMENT

The preferred embodiment of the invention provides for an image processing system that utilizes data from an analysis of image content to manipulate light source intensity to provide image brightness control for a microdisplay panel based presentation devices. Preferably, the intensity of each of a set of red, green, and blue light sources is individually controlled to vary the overall illumination of the microdisplay panel, while maintaining white light integrity.

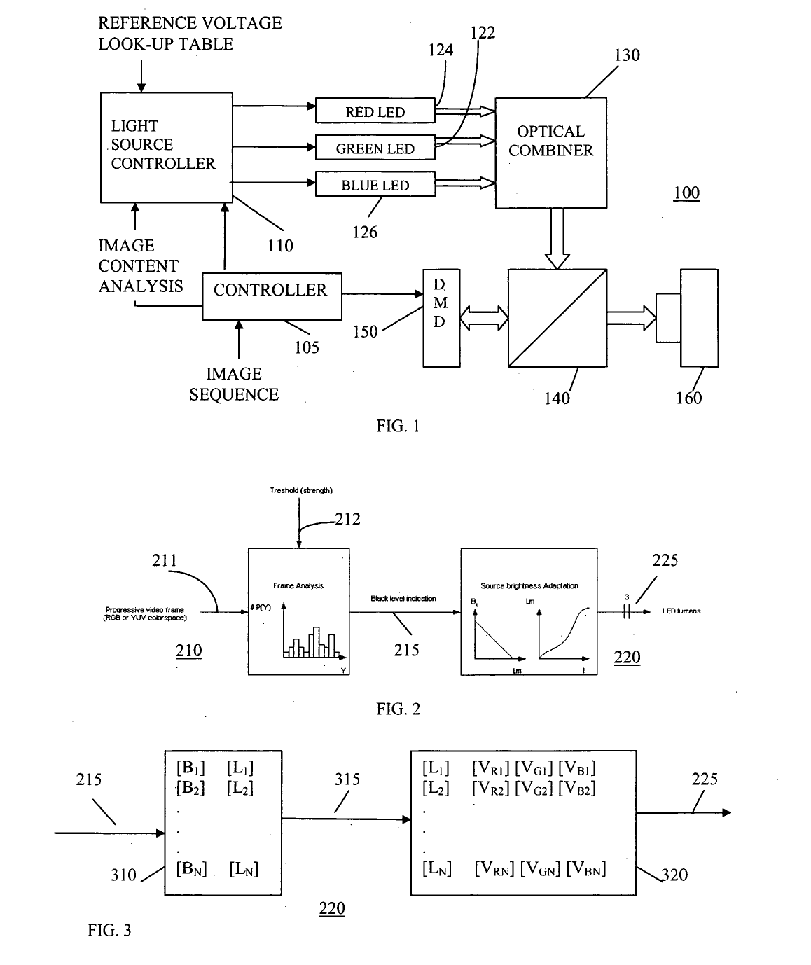

FIG. 1 shows a digital micro-mirror device (DMD) based image presentation device 100, in accordance with the preferred embodiment of the invention. The only elements necessary for the understanding of the invention are shown as traditional DMD based image projection systems which are well-known in the art. The image presentation device 100 of the preferred embodiment is a rear projection television system, but can also be a front projector, rear projector, or other microdisplay based system. The device 100 utilizes red, green, and blue light-emitting diodes (LEDs) 122, 124, 126 as light sources. Other types of light sources such as lasers or lamps are also contemplated. The light sources 122, 124, 126 are individually controllable to produce light that is directed to an optical combiner 130. The optical combiner is preferably formed from a combination of collimation lenses, condenser lenses, and dichroic prisms that together form part of a light engine for a DMD based system. Various configurations of light engines that may be used with the present invention are common in the art.

The optical combiner is coupled to a prism 140 which redirects light outputted from the optical combiner to a DMD panel device 150. Those skilled in the art will recognize the DMD panel device 150 comprises a large number of small mirrors that selectively reflect light, in conjunction with the processing of an image. These small mirrors may be microscopic in size. The light travels through the prism 140 and onto projection optics 160 for display on a screen (not shown). The DMD panel device 150 and light source controller 110 operate under the control of a controller 105 that manages the processing of images or sequence of images. The controller 105 outputs data derived from image frame analysis for use by a light source controller 110. The controller 105 is preferably a digital light processor (DLP) application specific integrated circuit (ASIC), commercially available from the Texas Instruments Corporation. Although the preferred embodiment utilizes a DMD panel device, the concepts of the invention are readily adaptable to the use of other microdisplay devices, such as liquid crystal display (LCD) panels, liquid crystal on silicon (LCOS) panels, and the like.

According to the present invention, the light source controller 110 is responsive to image content analysis data to derive or obtain reference data or control values for individually adjusting the intensity of output for each of the light sources 122, 124, 126, in order to enhance image processing. Some DLP ASICs have an output signal for optical shutter or aperture control which may be utilized as representative of image content or frame analysis data. Such output signal may also be processed to obtain scene brightness data or the desired black level.

FIG. 2 shows a representation of a transformation system for generating light source controlling signals, in accordance with the present invention. FIG. 3 shows look-up tables used in the transformation system of FIG. 2. Preferably, a frame analysis is done on each frame of image data as shown in graph 210. The video frame may be a progressive video frame with data representing a red, green, blue (RGB) or luminance and chrominance (YUV) components. Other image data representation systems are also contemplated. Each frame 210 is analyzed for pixel content, such as by comparing the pixels in a frame to a particular threshold 212 to determine the desired black level or scene brightness indicator or signal 215 corresponding to a particular frame. Preferably, a histogram analysis is used to determine scene brightness.

The black level indicator 215 is preferably mapped, via a look-up table, to obtain a representative relative light strength value 315 as shown in table 310 of FIG. 3. The relative light strength value 315 is preferably expressed as a fractional value having a numerical range between 0 and 1. Those skilled in the art will recognize that this numerical range may take other forms. The relative light strength value 315 is used to obtain or derive reference voltage values V_{R}, V_{G}, V_{B}, from table 320 for providing current to the red, green, and blue LEDs. In this manner, the light source controller manipulates a reference voltage signal to adjust or limit current throughput. This works to selectively vary the intensity or lumen output for one or more of the LEDs to achieve a particular illumination level corresponding to each image frame. Light from the adjusted light sources is applied to one or more that are processed image frames subsequently processed to obtain an adjustment in contrast ratio, or other color characteristics, to enhance image processing. Preferably, the values for the required LED reference voltages are predetermined, taking into consideration the non-linear relationship of current to lumens output for the particular light source, and also calculated to provide a particular white light characteristic when light from the various light sources is combined. In other words, it is desirable to ensure white point integrity when adjusting the output of the LEDs. Derivation of the adjustment values for the light sources may also be done through algorithmic means, rather than use of a look-up table.

In general, the image presentation device 100 of the preferred embodiment operates to process a sequence of image frames that form a moving image scene. Scene brightness data, or a derivative thereof, is obtained for at least a portion of the sequence of image frames, preferably from the digital light processor integrated circuit. The scene brightness data is used as a basis for obtaining values for setting or adjusting the intensity output of one or more light sources used to process the sequence of image frames. The values obtained are used to adjust the light sources while processing subsequent-image frames in the sequence to achieve an adjustment in contrast ratio.

The present invention provides significant advantages over the prior art. User-perceived contrast ratio can be significantly enhanced by the manipulation of the lumen output of light sources, such as red, green, and blue LED sources, when processing image frames, in addition to color manipulation traditionally provided by microdisplay panel devices. A scene brightness indicator, preferably generated using a histogram analysis, is used to limit the maximum source light flux as a function of the darkness of the scene, and this calculation may be done on a frame-by-frame basis. By using individualize control of the light sources to control source light flux, the expense and performance issues associated with electromechanical optical shutter solutions, now commonly used in the art, are avoided. Other advantages associated with the present invention include the potential for system designs that are simpler, easier to manufacture, and that have lower cost, longer lifetime, and better performance, particularly in the area of contrast ratio.

While the preferred embodiments of the invention have been illustrated and described, it will be clear that the invention is not so limited. Numerous modifications, changes, variations, substitutions and equivalents will occur to those skilled in the art without departing from the spirit and scope of the invention as defined by the appended claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method for image processing to improve perceived contrast comprising the steps of
obtaining values for each of a plurality of light sources based on an analysis of light content for at least one image frame of a sequence of image frames; and
processing at least a portion of the sequence of image frames-by adjusting the intensity of output for each of the plurality of light sources according to the obtained values.

2. A method for image processing to improve perceived contrast comprising the steps of:
obtaining a scene brightness indicator for an image frame from a sequence of image frames that form a moving image scene;
obtaining values for adjusting a plurality of light sources based on the scene brightness indicator; and
selectively adjusting the plurality of lights sources using the obtained values while processing the sequence of image frames.

3. The method of claim 2, wherein the plurality of light sources comprises red, blue, and green light sources.

4. The method of claim 3, wherein the red, blue, and green light sources, comprise red, blue, and green light-emitting diodes, respectively.

5. The method of claim 4, wherein the step of adjusting comprises the step of manipulating a reference voltage signal to limit current throughput to at least one of the red, blue, and green light-emitting diodes.

6. The method of claim 4, wherein the step of obtaining values comprises the step of accessing a look-up table of predetermined adjustment values calculated to provide a particular white light characteristic when the red, green, and blue light sources are combined.

7. The method of claim 4, wherein the scene brightness indicator is derived from an optical shutter control signal.

8. The method of claim 4, wherein the scene brightness indicator is generated from data representing a histogram.

9. A method for processing a sequence of image frames that form a moving image scene, comprising the steps of:
processing at least a first portion of the sequence of image frames using a histogram analysis to obtain scene brightness data;
obtaining values for each of a plurality of light sources based on the scene brightness data;
adjusting the plurality of light sources according to the obtained values; and
applying the adjusted plurality of light sources to at least a second portion of the sequence of image frames to obtain an adjustment in contrast ratio.

10. The method of claim 9, wherein the plurality of light sources comprises red, blue, and green light-emitting diodes.

11. The method of claim 10, wherein the step of adjusting comprises the step of manipulating a reference voltage signal to limit current throughput to one or more of the red, blue, and green light-emitting diodes.

12. The method of claim 10, wherein the step of obtaining-values comprises the step of:
accessing a look-up table of predetermined adjustment values calculated to provide a particular white light characteristic when light from the plurality of light sources are combined.

13. A method for processing a sequence of image frames, comprising the steps of:
obtaining a signal from a digital light processor integrated circuit representing scene brightness data for at least a portion of the sequence of image frames;
obtaining values for adjusting each of a plurality of light sources based on the obtained signal;
manipulating a reference voltage signal to limit current throughput to adjust one or more of the plurality of light sources according to the obtained values; and
applying the adjusted one or more of the plurality of light sources to at least a portion of the sequence of image frames to obtain an adjustment in contrast ratio.

14. The method of claim 13, wherein the plurality of light sources comprises red, blue, and green light-emitting diodes.

15. The method of claim 14, wherein the step of obtaining values comprises the step of accessing a look-up table of predetermined adjustment values calculated to provide a particular white light characteristic when light from the plurality of light sources are combined.

16. An image presentation device for processing a sequence of image frames, each image frame having a particular data content, the device comprising:
a microdisplay panel device;
at least one light source operable to emit light having one of a plurality of colors;
an optical light engine for directing light from at least one light source to the microdisplay panel device; and
a controller responsive to the data content of one or more image frames of the sequence of image frames, to selectively vary intensity for the at least one light source to achieve a particular illumination level for one or more subsequently processed image frames.

17. The image presentation device of claim 16, further comprising a look-up table having a mapping between desired illumination levels and values for each of the at least one light source, wherein the controller is responsive to information derived from the data content of each image frame to select corresponding values from the look-up table.

18. The image presentation device of claim 16, wherein the controller is responsive to information derived from the data content of each image frame to vary intensity over at least three levels for each of the at least one light source.

19. The image presentation device of claim 16, wherein the at least one light source comprises a plurality of light-emitting diodes.
